(19) United States
(12) Patent Application Publication
(10) Pub. No.: US 2026/0086214 A1
(43) Pub. Date: Mar. 26, 2026

(54) SMART DISTRIBUTION VEHICLE AND ASSEMBLY METHOD THEREFOR

(71) Applicants: Hyundai Motor Company, Seoul (KR); Kia Corporation, Seoul (KR)

(72) Inventors: Kye Un Ahn, Gyeonggi-do (KR); Young Jin Jung, Chungcheongnam-do (KR); Sung Hyun Kim, Gyeonggi-do (KR); Beom Jun Lee, Gyeonggi-do (KR)

(21) Appl. No.: 19/111,927

(22) PCT Filed: Dec. 20, 2022
(86) PCT No.: PCT/KR2022/020792

§ 371 Date: Mar. 14, 2025

(30) Foreign Application Priority Data
Oct. 14, 2022 (KR) 10-2022-0132532

(51) Int. Cl. G01S 7/497; G01S 17/86; G01S 17/87; G01S 17/931

(52) U.S. Cl. CPC G01S 7/4972; G01S 17/86; G01S 17/87; G01S 17/931

(57) ABSTRACT

The present invention relates to a smart distribution vehicle comprising: a sensor part for detecting an object; a first support part for supporting the sensor part; a second support part for supporting the sensor part on the upper portion of the first support part; and a position-regulating part for regulating the second support part so as to maintain initial position information of the sensor part while the sensor part is supported on the second support part, and, upon replacement of the sensor part, aligning initial position of a replaced sensor part on the basis of the initial position information of the sensor part.

### TECHNICAL FIELD

The present disclosure relates to a smart distribution vehicle and a control method thereof, which can shorten the setting time of a replacement sensor part when replacing a sensor part.

### BACKGROUND ART

In general logistics warehouses and factories, as well as smart factories where products of different specifications are manufactured using various parts, smart distribution vehicles are being introduced for flexible and efficient supply and transportation of parts, etc.

Smart distribution vehicles are a concept that collectively refers to autonomous mobile robots (AMRs), automated guided vehicles, and unmanned stackers or forklifts, and these smart distribution vehicles can move and perform tasks under the control of a control system.

At this time, a smart distribution vehicle can move by estimating the location thereof on the basis of smart factory map information generated and collected through a LiDAR sensor or a camera sensor to detect an obstacle. In addition, for smooth movement of smart distribution vehicles, it is essential to set the appropriate angle and height of a sensor to accurately generate map information.

However, when a sensor breaks down and is replaced with another sensor, the replacement sensor needs to be initially set exactly to the position where the replaced sensor was set before replacement. Otherwise, smooth movement may be difficult due to inconsistency in map information. Moreover, depending on the complexity of the map, setting the initial position of the sensor after replacement may take a lot of time, which is problematic.

The description provided above as related art of the present disclosure is just for helping understand the background of the present disclosure and should not be construed as being included in the related art known by those skilled in the art.

### DISCLOSURE

### Technical Problem

The present disclosure is intended to solve the above problems occurring in the related art. An objective of the present disclosure is to provide a smart distribution vehicle that can shorten the time required for initial setup of a replacement sensor part on the basis of initial location information when replacing a sensor part, and an assembly method of the smart distribution vehicle.

The objectives of the present disclosure are not limited to those mentioned above, and other objectives not mentioned will be clearly understood by those skilled in the art from the description below.

### Technical Solution

In order to achieve the above mentioned objectives, there is provided a smart distribution vehicle including: a first support part configured to support a sensor part for detecting an object; a second support part configured to support the sensor part at the top of the first support part; and a position regulation part configured to regulate the second support part so that initial position information of the sensor part is maintained while the sensor part is supported on the second support part, and to align, upon replacement of the sensor part, an initial position of a replacement sensor part on the basis of the initial position information of the sensor part.

For example, the sensor part may include a 2D LiDAR sensor, a 3D LiDAR sensor, and a 3D camera sensor.

For example, the sensor part may be supported at the rear and bottom by the second support part.

For example, the second support part may be provided to be detachable from the position regulation part.

For example, the second support part may be replaced together when replacing the sensor part.

For example, the second support part may be provided to be detachable from the position regulation part.

For example, the position regulation part may be provided in a plural number and may connect the first support part and the second support part in a vertical direction.

For example, the initial position information of the sensor part may include at least one of information on a slope formed by the second support part and the sensor part, and information on a width, a height, and an angle formed by the first support part and the sensor part.

For example, the position regulation part may ensure that the initial position information of the sensor part is maintained on the basis of spatial map information obtained by the sensor part.

In addition, according to an embodiment of the present disclosure, there is provided an assembly method of a smart distribution vehicle, the method may include: determining a failure of a sensor part on the basis of initial position information of the sensor part in the smart distribution vehicle including the sensor part for detecting an object, a first support part to support the sensor part, a second support part to support the sensor part at a top of the first support part, and a position regulation part to regulate the second support part; replacing the sensor part and the second support part when the sensor part fails; and aligning, upon replacement of the sensor part, an initial position of a replacement sensor part on the basis of the initial position information of the sensor part.

For example, the sensor part may include a 2D LiDAR sensor, a 3D LiDAR sensor, and a 3D camera sensor.

For example, the second support part may be provided to be detachable from the position regulation part.

For example, the position regulation part may be provided in a plural number and may connect the first support part and the second support part in a vertical direction.

For example, the initial position information of the sensor part may include at least one of information on a slope formed by the second support part and the sensor part, and information on a width, a height, and an angle formed by the first support part and the sensor part.

For example, the position regulation part may ensure that the initial position information of the sensor part is maintained on the basis of spatial map information obtained by the sensor part.

### Advantageous Effects

According to various embodiments of the present disclosure as described above, it is possible to shorten the time required for initial setup of a replacement sensor part on the basis of initial location information when replacing a sensor part. In addition, due to the shortened time, a smart distribution vehicle can be started immediately, improving operation rates.

The effects of the present disclosure are not limited to those mentioned above, and other effects not mentioned will be clearly understood by those skilled in the art from the description below.

### DESCRIPTION OF DRAWINGS

FIG. 1 is a block diagram showing an example of a smart factory configuration that can be applied to embodiments of the present disclosure.

FIG. 2 is a block diagram showing an example of a control system configuration that can be applied to embodiments of the present disclosure.

FIG. 3 is a block diagram showing an example of a smart distribution vehicle configuration that can be applied to embodiments of the present disclosure.

FIG. 4 is a block diagram showing an example of the appearance of a smart distribution vehicle that can be applied to embodiments of the present disclosure.

FIG. 5 is a flowchart showing an example of a driving process of a smart distribution vehicle that can be applied to embodiments of the present disclosure.

FIG. 6 is a block diagram showing an example of a sensing part constituting a smart distribution vehicle according to an embodiment of the present disclosure.

FIG. 7 is a configuration diagram showing an example of a smart distribution vehicle configuration according to an embodiment of the present disclosure.

FIG. 8 is a flowchart showing an example of a method for assembling a smart distribution vehicle according to an embodiment of the present disclosure.

### MODE FOR INVENTION

Hereafter, embodiments of the present disclosure will be described in detail with reference to the accompanying drawings, but identical or similar Components are given the same reference numerals regardless of the numbers in the drawings, and redundant descriptions thereof will be omitted. The terms “module” and “unit” that are used for Components in the following description are given or used interchangeably only for the ease of writing the specification, and do not have distinct meanings or roles in themselves. In the following description, if it is decided that the detailed description of known technologies related to the present disclosure makes the subject matter of the embodiment described herein unclear, the detailed description is omitted. In addition, the accompanying drawings are provided only for easy understanding of ( the embodiment disclosed in the specification, and the technical spirit disclosed in the specification is not limited by the accompanying drawings, and all changes, equivalents, and replacements should be understood as being included in the spirit and scope of the present disclosure.

Terms including ordinal numbers such as “first”, “second”, etc. may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

Singular forms are intended to include plural forms unless the context clearly indicates otherwise.

It will be further understood that the terms “comprise (include)” or “have” used in this specification, specify the presence of stated features, steps, operations, components, parts, or a combination thereof, but do not preclude the presence or addition of one or more other features, numerals, steps, operations, components, parts, or a combination thereof.

In addition, the terms “unit” or “control unit” included in motor control unit (MCU), hybrid control unit (HCU), etc. are just widely used terms for naming controllers that control specific vehicle functions, and do not mean generic function units. For example, each controller may include a modem/transceiver that communicates with another controller or a sensor to control corresponding functions, a memory that stores an operating system or logic commands and input/output information, and one or more processors that perform determination, calculation, decision, etc. for controlling the corresponding functions. Depending on the implementation, one processor may be responsible for operations on multiple controllers.

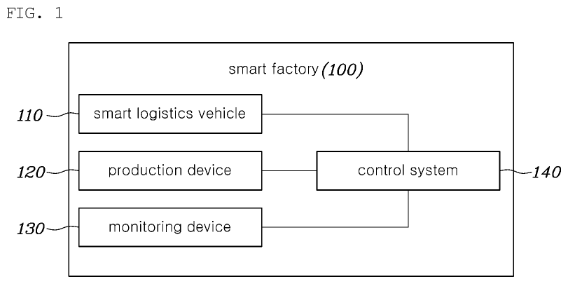

First, the configuration of a smart factory in which a smart distribution vehicle according to an embodiment is deployed and operated will be described with reference to FIG. 1.

FIG. 1 is a block diagram showing an example of a smart factory configuration that can be applied to embodiments of the present disclosure.

Referring to FIG. 1, a smart factory 100 may include a smart distribution vehicle 110, a production device 120, a monitoring device 130, and a control system 140.

Depending on the production process and target production rate, the smart factory 100 may be provided with a plurality of smart distribution vehicles 110, a plurality of production devices 120, and a plurality of monitoring devices 130. Below, each component will be explained.

First, the smart distribution vehicle 110 may include an autonomous mobile robot (hereinafter referred to as “AMR” for convenience), an automated guided vehicle (hereinafter referred to as “AGV” for convenience) and an unmanned stacker or forklift. Depending on the operation policy of the smart distribution vehicle 110 in the smart factory 100, only one type of AGV or AMR may be operated, or AGV and AMR may be operated together within a single smart factory 100.

The AGV generally performs required operations (movement, direction change, stop, etc.) within the smart factory 100 by recognizing and following guidance instruments placed on the floor to guide the AGV. In this case, the guidance instruments may refer to optically recognizable markers (spots, 2D codes, etc.), tags that can be recognized in a non-contact manner at close range (e.g., NFC tags, RFID tags, etc.), magnetic strips, wires, etc., but these are examples and are not necessarily limited thereto. The guidance instruments may be placed continuously on the floor or discontinuously spaced apart from each other. Because the AGV basically performs operations through recognition and following of the guidance instruments, the guidance instruments are required to be installed in advance before operation. When the AGV needs to be moved to a new path or an existing path needs to be modified, it is necessary to physically construct or modify the guidance instruments. In addition, since the AGV does not deviate from a path set by means of the guidance instruments, when an obstacle is detected on or around the path, the AGV typically stops until the detected obstacle disappears or receives separate control. In the operation of the AGV, the control system 140 needs to control the AGV on the basis of the guidance instruments. Thus, the control system 140 may send commands, such as “drive until a third marker is recognized”, “change the heading direction 90 degrees when the third marker is recognized” from the current location, to the AGV in units of individual commands or missions containing multiple commands (e.g., recovery, supply, charging, patrol, etc.).

The AMR may determine the current location (i.e., positioning) through surrounding detection, and may be said to be most different from the AGV in that the AMR is capable of path planning using positioning and maps. Thus, if a map with compatible coordinates is shared between the AMR and the control system 140, the control system 140 is able to control the AMR by instructing the AMR a path based on coordinates. In addition, when an obstacle is detected while driving, the AMR may plan an avoidance path to avoid the obstacle and then return to the original path. The function of the control system 140 to plan the path of the AMR to one or more transit coordinates may be referred to as global path planning, and the function of the AMR to plan a path or an avoidance path between transit coordinates according to global path planning may be referred to as local path planning.

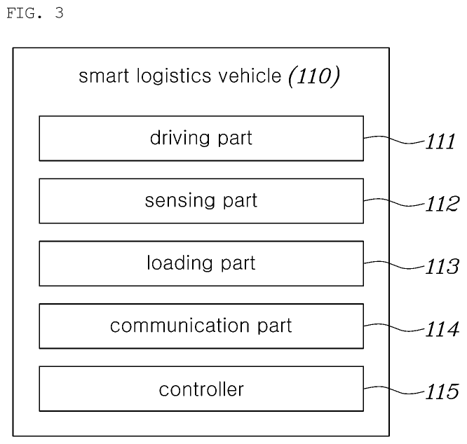

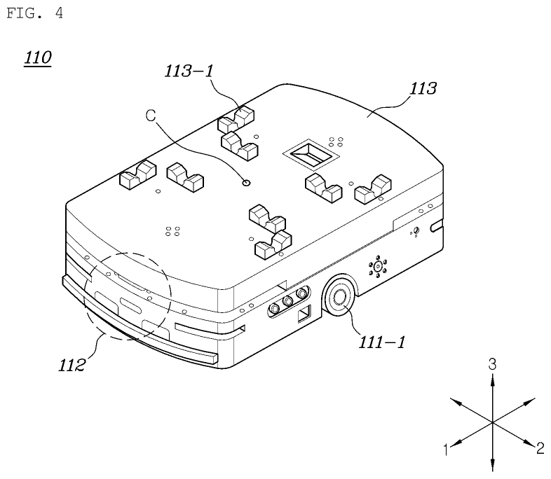

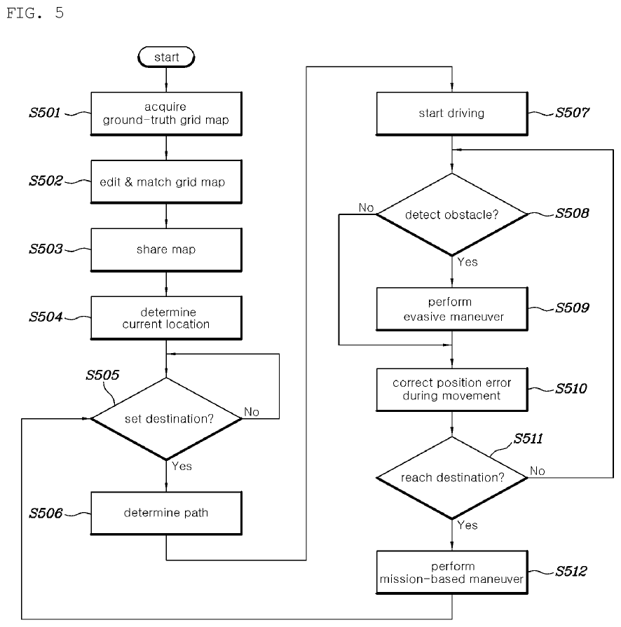

A more detailed configuration of the smart distribution vehicle 110 will be described later with reference to FIGS. 3 and 4, and a driving control process of the AMR will be described later with reference to FIG. 5.

Next, the production device 120 may refer to a device (e.g., robot arm, conveyor belt, etc.) that performs the production process of a product in the smart factory 100. In a broader sense, the production device 120 may refer to a device deployed to assist in performing missions such as entry and exit of the smart distribution vehicle 110 when the production process is performed by humans. The device deployed to assist in mission performance may be a device that detects the status of a designated location where a pallet carried by the smart distribution vehicle 110 can be placed or collected within an area where a specific production process is performed, a device that determines process progress, means to block access to an area, etc., but is not limited thereto.

For example, the production device 120 is controlled through a programmable logic controller (PLC) and may communicate with the control system 140 in relation to process progress.

The monitoring device 130 may perform the function of obtaining information to determine the situation within the smart factory 100 and transmitting the obtained information to the control system 140. For example, the monitoring device 130 may include a camera, a proximity sensor, etc., but is not necessarily limited thereto.

The control system 140 may communicate with the above-described components 110, 120, and 130 to obtain information necessary for operation of the smart factory 100 or control each component. For example, the control system 140 may perform dispatching of the smart distribution vehicle 110, path setting, mission allocation, process management for each product, material management, etc.

In the implementation, the control system 140 may include an AMR/AGV control system (ACS) that controls surrounding process facilities on the basis of the position of the AGV/AMR and performs mission-based control of the AGV/AMR, and a mobile robot integrated monitoring system (MoRIMS) that integrates and controls two or more AMR/AGV control systems. The MoRIMS may perform control of status and path of all smart distribution robots 110, distribution flow settings, and traffic in the smart factory 100 by means of individual ACSs. For example, when the ACSs are provided as smart distribution robot units of the same manufacturer or model, the MORIMS may perform integrated control to prevent collisions, such as analysis of bottleneck levels in intersection/overlapping areas, acceleration/deceleration control, and regeneration of avoidance paths through heterogeneous traffic distribution control, on the basis of information obtained through the ACSs.

In addition, the MoRIMS may also have a manufacturing execution system (MES) as an upper-level control entity thereof, and the MES may be linked to an advanced planning & scheduling (APS).

In addition to the configurations 110, 120, 130, and 140 of the smart factory 100 described above, devices for mutual communication between individual components such as beacons, repeaters, access points (APs), etc., chargers for charging the smart distribution vehicle 110, loading spaces for storing or loading parts, spaces where finished products or intermediate products are stored, traffic lights, circuit breakers, waiting spaces for idle smart distribution vehicles 110, etc. may be appropriately arranged within the smart factory 100.

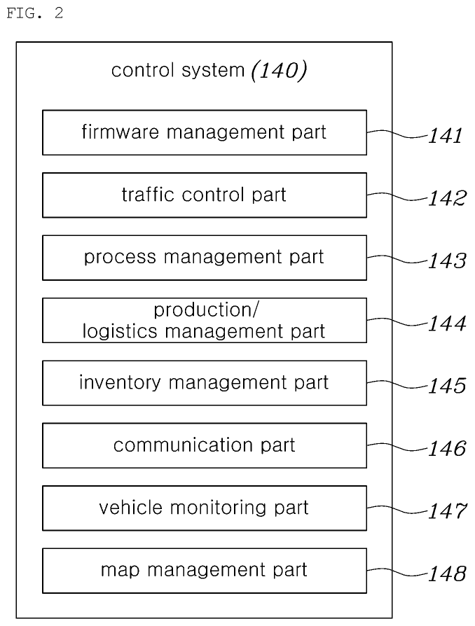

Hereinafter, the configuration of the control system 140 that can be applied to the embodiments of the present disclosure will be described with reference to FIG. 2.

FIG. 2 is a block diagram showing an example of a control system configuration that can be applied to embodiments of the present disclosure. Each component shown in FIG. 2 mainly represents components related to the embodiments of the present disclosure, and in actual implementation of the control system 140, more or fewer components may be included.

Referring to FIG. 2, the control system 140 may include a firmware management part 141, a traffic control part 142, a process management part 143, a production/distribution management part 144, an inventory management part 145, a communication part 146, a vehicle monitoring part 147, and a map management part 148.

The firmware management part 141 may acquire the latest firmware of the smart distribution vehicle 110 through the communication part 146, transmit the firmware to the smart distribution vehicle 110, and perform a firmware update to keep the firmware of the smart distribution vehicle 110 up to date.

The traffic control part 142 may control traffic lights and barriers on the basis of a path of the smart distribution vehicle 110, and recalculate the path of the smart distribution vehicle 110 according to traffic.

The process management part 143 may define processes for each product and manage missions such as process progress and progress location.

The production/distribution management part 144 may dispatch the smart distribution vehicle 110 on the basis of the mission.

The inventory management part 145 manages the location and quantity of each material, and this information may be used for more efficient process operation, for example, departing the smart distribution vehicle 110 to the destination ahead of the time when the actual assembly/consumption of a material is detected for pallet pickup or recovery, etc.

The communication part 146 may communicate with internal components of the smart factory 100, such as the smart distribution vehicle 110, the production device 120, and the monitoring device 130, as well as with external entities such as a firmware update server, etc.

The vehicle monitoring part 147 may monitor the location, path, battery status, communication status, power train status, etc. of the individual smart distribution vehicle 110. In this case, the path is a concept that includes a waypoint-based global path and a real-time local path. In addition, the battery status may include voltage, current, temperature, peak values of voltage and current, state of charge (SOC), state of health (SOH), etc. The communication status may include information about the currently active communication protocol (Wi-Fi, etc.), connected AP, distance from the AP, channel in use, etc. The power train status may include drivetrain load, temperature, RPM, etc.

In addition, the vehicle monitoring part 147 may check the mission currently assigned to the individual smart distribution vehicle 110, operation mode, firmware version, etc.

The map management part 148 may acquire map data in the form of a grid map acquired while the AMR of the smart distribution vehicles 110 drives inside the smart factory 100, and provide a tool that allows a factory manager to edit the acquired map data. Through the editing of map data, zones in which the smart distribution vehicle 110 performs one or more preset operations upon entry, virtual lanes, intersections, and no-entry zones may be set, but this is an example and is not necessarily limited thereto. In addition, through the communication part 146, the map management part 148 may distribute the map to the remaining smart distribution vehicles 110 other than the smart distribution vehicle 110 that acquired the initial grid map through actual driving.

Next, the smart distribution vehicle will be described with reference to FIGS. 3 and 4.

FIG. 3 is a block diagram showing an example of a smart distribution vehicle configuration that can be applied to embodiments of the present disclosure.

Referring to FIG. 3, the smart distribution vehicle 110 may include a driving part 111, a sensing part 112, a loading part 113, a communication part 114, and a controller 115. Below, each component will be described.

The driving part 111 may include a torque source, wheels, and suspension involved in moving, steering, and stopping the smart distribution vehicle 110. The torque source may be an electric motor supplied with power from a built-in battery (not shown). The wheels may include one or more driving wheels that receive driving force from the torque source and a non-driving wheel that rotates due to movement of a vehicle body without receiving driving force. Depending on the implementation, when a plurality of driving wheels are provided, the torque source is matched for each driving wheel so that the rotation of each driving wheel may be controlled independently. In this case, by varying the rotation directions of different driving wheels, steering may be achieved by rotating the vehicle body without a separate steering means. At least some of the non-driving wheels may be composed of caster-type wheels, but this is an example and is not necessarily limited thereto.

The sensing part 112 is for detecting the surrounding environment or self-operation status of the smart distribution vehicle 100. The sensing part 112 may include at least one of 2D and 3D laser scanners (e.g., LiDAR), a 3D vision (stereo) camera, a multi-axis gyro sensor, an acceleration sensor, wheel encoder, and a proximity sensor.

The encoder may output information for determining how much a wheel has rotated using light emitted from a light-emitting device (e.g., a photodiode). For example, the encoder may count the number of slits arranged along the circumference of a wheel or a disk rotating with the wheel during unit time. The controller 115 is capable of performing odometry, which estimates displacement by analyzing the amount of position change compared to time using data acquired by means of the encoder and the gyro sensor. However, the displacement estimated based on encoder data may differ from the actual displacement due to wheel slip or wear (change in wheel radius). Thus, when performing odometry, the controller 115 may correct information collected from the wheel and gyro sensor for noise and error using a predetermined algorithm (e.g., Extended Kalman Filter (EKF)) and output results that tend to be close to actual values. Such odometry may be particularly useful when localization is not possible using a 2D laser scanner, which will be described later.

The 2D laser scanner may scan the surrounding environment by emitting a laser to the surrounding area through a rotating reflector and detecting a reflected signal. At this time, the intensity of the reflected signal and the time difference between emission/reception may be analyzed to output a point-cloud shape detection result.

The 3D vision camera may calculate the distance to an object on the basis of the parallax between two cameras separated by a certain distance, that is, the pixel distance between images taken by each camera. At this time, a texture projector that projects infrared light of a predetermined pattern may be provided to enable detection of a flat object of the same color (e.g., a white wall).

Generally, the 2D laser scanner is used for mapping, navigation, object recognition, etc., and the 3D camera may be used especially for obstacle avoidance during navigation, but this is an example and is not necessarily limited thereto.

The loading part 113 is a means for loading goods to be transported, and may be a top plate itself on the top of a vehicle body, a table placed on the top plate, a lift, a turntable rotating along a vertical axis, a forklift, a conveyor, or a combination thereof. In the case of a forklift, telescopic and tilting functions may be provided similar to a stacker.

The communication part 114 may communicate with other components in the smart factory 100, such as the production device 120 and the control system 140. The communication part 114 may also support communication between smart distribution vehicles 110, and communicate with a charger when performing a charging mission.

The controller 115 is the entity that performs overall control of each of the above-described components 111, 112, 113, and 114. The controller 115 may perform current mission, current location, and destination determination, as well as path planning and control of the loading part on the basis of information obtained from the control system 140 via the communication part 114.

FIG. 4 is a block diagram showing an example of the appearance of a smart distribution vehicle that can be applied to embodiments of the present disclosure.

Referring to FIG. 4, an example of AMR is shown as a smart distribution vehicle 110. The vehicle body may have a track-like planar shape with a long axis extending along a first axis direction. One driving wheel 111-1 is disposed in the center of the vehicle body in the first axis direction, and may be disposed on one side in a second axis direction, while another driving wheel (not shown) may be disposed on the other side to face the one driving wheel 111-1 in the second axis direction. Such driving wheel arrangement may be referred to as “differential drive (DD)”. Although not shown in FIG. 4, two or more non-driving wheels may be disposed on the lower part of the vehicle body. In this case, when the two driving wheels rotate in the same direction and at the same speed, forward or backward movement is possible along the first axis direction, and when rotating at the same speed in opposite directions, the driving wheels may rotate based on the rotation axis extending along a third axis direction and passing through a plane center C of the vehicle body. In addition, the sensing part 112 may be placed on the front surface of the vehicle body, and the loading part 113 may be placed on the upper surface of the vehicle body. The loading part 113 may be configured to be lifted and lowered along the third axis direction, and a rack or tray, etc. may be fixed to the upper surface thereof be means of a guide 113-1.

However, the AMR shape of FIG. 4 described above is an example, and the AGV may have a similar shape, or the AMR may have a different shape.

Next, the driving process of the smart distribution vehicle 110 will be described with reference to FIG. 5.

FIG. 5 is a flowchart showing an example of a driving process of a smart distribution vehicle that can be applied to embodiments of the present disclosure. In FIG. 5, for convenience, it is assumed that the smart distribution vehicle 110 is an AMR capable of positioning and local path planning.

Referring to FIG. 5, first, the AMR may acquire (S501) a ground-truth grid map through LiDAR, etc. while driving inside the smart factory 100.

*When the AMR transmits the acquired grid map to the control system 140, grid map editing and matching processes may be performed (S502) in the map management part 148 of the control system 140. In this case, the editing process may include a process of setting the above-described various zones in the above-described grid map, a process of assigning a cost to each grid, etc. At this time, cost assignment may be performed in a way that a higher cost is assigned the closer to an obstacle or a no-entry zone so that the AMR does not move around the obstacle or into a zone where the AMR should not be entered. This is because when planning a local path, the AMR selects the set of cells with the lowest cost between waypoints as the path.

In addition, the map matching process may refer to a process of matching coordinates between a CAD map used in the design of the smart factory 100, the ground-truth grid map (LiDAR map), and the topology map that has gone through the editing process.

Thereafter, the control system 140 may share (S503) the topology map to all AMRS in the factory through the communication part 146.

Subsequent steps may be processes applied to individual AMRS.

The AMR may determine the current location (localization) (S504) on the map on the basis of the sensor data of the sensing part 112 and the acquired map. For example, the AMR may determine the current location by comparing the surrounding terrain and map acquired through LiDAR based on feature points.

The control system 140 may select a specific AMR and assign a mission, and the mission may be assigned one or more waypoints, typically determined through global path planning. The waypoint may be defined as a coordinate on a map, and may be accompanied by information about the direction (i.e., heading) the AMR should face at the coordinate. According to this mission assignment, a destination may be set in AMR (Yes in S505), and the AMR may perform local path planning between waypoints on the basis of the costs of the topology map (S506).

Once the path is determined, the AMR starts driving (S507), and when an obstacle is detected by the sensing part 112 while driving (Yes in S508), the AMR may perform evasive maneuver (S509) by performing local path search to bypass the detected obstacle. In some cases, and according to an evasive maneuver or failure of the evasive maneuver, the control system 140 may update the mission of the corresponding AMR.

In addition, the AMR may correct position errors (S510) during movement through the odometry technique described above while driving until reaching the destination.

After reaching the destination (S511), the AMR may perform mission-based maneuvers (S512). For example, the AMR may determine whether the conditions for entering a specific process area are cleared, retrieve an empty pallet from the destination, or drop the load loaded on the loading part 113.

An embodiment of the present disclosure proposes the smart distribution vehicle 110 that may shorten the time required for initial position setting by simply replacing a sensor part on the basis of information about an initial position regulated through mechanical settings when the sensor part fails.

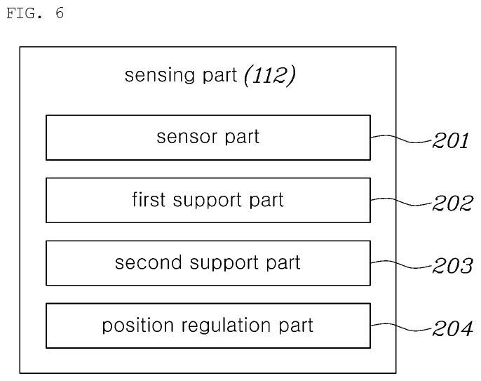

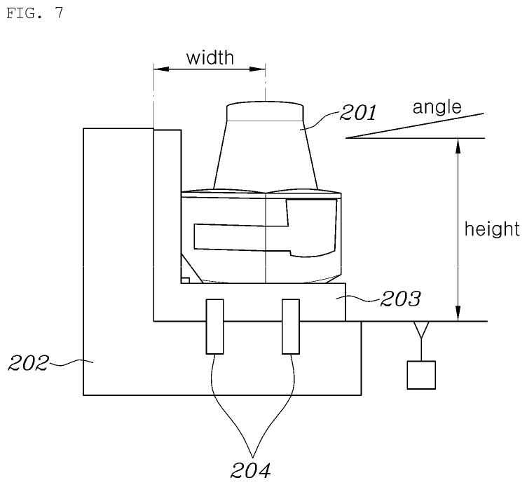

Hereinafter, the smart distribution vehicle according to an embodiment will be described with reference to FIGS. 6 and 7.

FIG. 6 is a block diagram showing an example of a sensing part constituting a smart distribution vehicle according to an embodiment of the present disclosure. In addition, FIG. 7 is a configuration diagram showing an example of a smart distribution vehicle configuration according to an embodiment of the present disclosure.

Referring to FIG. 6, to be specific, the sensing part 112 may include a sensor part 201, a first support part 202, a second support part 203, and a position regulation part 204. First, the first support part 202 may support the sensor part 201 for detecting an object. The sensor part 201 is not limited to examples of the above-described sensing part 112, such as 2D and 3D laser scanners (e.g., LiDAR), a 3D vision (stereo) camera, a multi-axis gyro sensor, an acceleration sensor, a wheel encoder, and a proximity sensor, and may also include devices that require assurance of initial setting information. Referring to FIG. 7, the first support part 202 is the AMR main body and may support the rear and lower surfaces of the second support part 203 and the position regulation part 204, which will be described later. The lower surface of the first support part 202 is formed in a flat structure to facilitate measurement of height information and angle information with the sensor part 201, while the rear surface of the first support part 202 may be formed in a structure orthogonal to the sensor part 201 to facilitate width information measurement.

In addition, the second support part 203 may support the sensor part 201 at the top of the first support part 202. Referring to FIG. 7, the rear and lower surfaces of the sensor part 201 may be supported by means of the second support part 203, similar to the first support part 202. The second support part 203 may be regulated between the first support part 202 and the sensor part 201 by means of the position regulation part 204, which will be described later. The second support part 203 is a fixture that can fix the sensor part 201 in an accurate position, and by simply replacing the second support part 203 in the first support part 202, immediate operation is possible on the basis of the initial position information of the sensor part 201 without setting separate parameters.

To be specific, when replacing the sensor part 201, the initial position alignment of the replacement sensor part 201 may be performed by the position regulation part 204. In this case, the position regulation part 204 may regulate the second support part 203 so that the initial position information of the sensor part 201 is maintained while the sensor part 201 is supported on the second support part 203. At this time, the position regulation part 204 may maintain initial location information on the basis of spatial map information detected through the sensor part 201, and may align the initial position of the sensor part 201 by preventing the initial position information from changing on the basis of the pre-sensed spatial map information when the sensor part 201 is replaced.

The initial position alignment method of the position regulation part 204 may be based on the initial position information of the sensor part 201 before replacement. In this case, the initial position information of the sensor part 201 may include at least one of slope information, height information, and angle information. The slope information may be obtained based on a slope formed by the sensor part 201 and the second support part 203, and the information on the width height, and angle may be obtained based on the width, height, and angle formed by the sensor part 201 and the first support part 202.

Thus, the position regulation part 204 regulates the position of the second support part 203 so that the initial position of the sensor part 201 is maintained, and by regulating the position of the second support part 203, the sensor part 201 is also regulated to the initial position thereof. In a state where the second support part 203 is fixed to the sensor part 201, when the sensor part 201 is replaced, the second support part 203 is also replaced, making it possible to quickly align the initial position of the replacement sensor part 201 on top of the first support part 202. To this end, the second support part 203 may be provided to be detachable from the position regulation part 204.

In addition, the position regulation part 204 may connect the first support part 202 and the second support part 203 in the vertical direction. The position regulation part 204 connecting the first support part 202 and the second support part 203 in the vertical direction not only makes it easy to reconnect when replacing the sensor part 201 and the second support part, but also makes it easy to obtain initial position information. In addition, when a plurality of position regulation parts 204 is configured, the fixing force may be increased upon connecting the first support part 202 and the second support part 203.

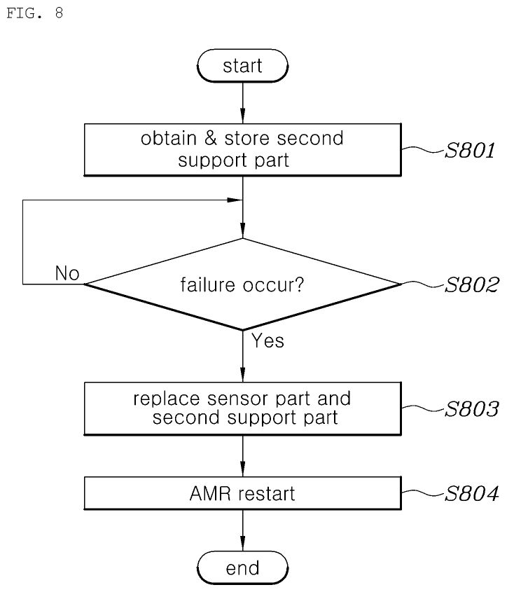

Based on the configuration of the smart distribution vehicle described above, the assembly method of the smart distribution vehicle according to an embodiment will be described with reference to FIG. 8.

FIG. 8 is a flowchart showing an example of a method for assembling a smart distribution vehicle according to an embodiment of the present disclosure.

Referring to FIG. 8 first, when the sensor part 201 breaks down, the second support part 203 required for replacement may be obtained and stored (S801). Afterwards, a failure of the sensor part 201 may be determined (S802). If the sensor part 201 is broken (YES in S802), while the second support part 203 is fixed to the sensor part 201, the second support part 203 is also replaced along with the replacement of the sensor part 201 (S803). Ultimately, by replacing the sensor part 201 and the second support part 203, the AMR may be restarted immediately by quickly aligning the initial position of the replacement sensor part 201 by means of the position regulation part 204 (S804).

In conclusion, according to various embodiments of the present disclosure as described above, it is possible to shorten the time required for initial setup of a replacement sensor part on the basis of initial location information when replacing a sensor part. In addition, due to the shortened time, a smart distribution vehicle may be started immediately, improving operation rates.

Meanwhile, the above-described disclosure may be implemented as computer-readable code on a program-recorded medium. Computer-readable medium includes types of recording devices that store data that can be read by a computer system. Examples of computer-readable medium include a hard disk drive (HDD), a solid state disk (SSD), a silicon disk drive (SDD), a ROM, a RAM, a CD-ROM, a magnetic tape, a floppy disk, an optical data storage device, etc. Therefore, the above detailed description should not be construed as limiting in any respect and should be considered illustrative. The scope of the present disclosure should be determined by reasonable interpretation of the appended claims, and all changes within the equivalent scope of the present disclosure are included in the scope of the present disclosure.

### DESCRIPTION OF NUMERALS

100: smart factory 110: smart distribution vehicle
120: production device 130: monitoring device
140: control system

1. A smart distribution vehicle comprising:
a first support part configured to support a sensor part for detecting an object;
a second support part configured to support the sensor part at a top of the first support part; and
a position regulation part configured to regulate the second support part so that initial position information of the sensor part is maintained while the sensor part is supported on the second support part, and to align, upon replacement of the sensor part, an initial position of a replacement sensor part based on the initial position information of the sensor part.

2. The vehicle of claim 1, wherein the sensor part comprises a 2D LiDAR sensor, a 3D LiDAR sensor, and a 3D camera sensor.

3. The vehicle of claim 1, wherein the sensor part is supported at a rear and a bottom by the second support part.

4. The vehicle of claim 1, wherein the second support part is provided to be detachable from the position regulation part.

5. The vehicle of claim 4, wherein the second support part is replaced together when replacing the sensor part.

6. The vehicle of claim 1, wherein the position regulation part is provided in a plural number and connects the first support part and the second support part in a vertical direction.

7. The vehicle of claim 1, wherein the initial position information of the sensor part includes at least one of information on a slope formed by the second support part and the sensor part, and information on a width, a height, and an angle formed by the first support part and the sensor part.

8. The vehicle of claim 1, wherein the position regulation part is configured that the initial position information of the sensor part is maintained based on spatial map information obtained by the sensor part.

9. An assembly method of a smart distribution vehicle, the method comprising:
determining a failure of a sensor part based on initial position information of the sensor part in the smart distribution vehicle including the sensor part for detecting an object, a first support part to support the sensor part, a second support part to support the sensor part at a top of the first support part, and a position regulation part to regulate the second support part;
replacing the sensor part and the second support part when the sensor part fails; and
aligning, upon replacement of the sensor part, an initial position of a replacement sensor part based on the initial position information of the sensor part.

10. The method of claim 9, wherein the sensor part comprises a 2D LiDAR sensor, a 3D LiDAR sensor, and a 3D camera sensor.

11. The method of claim 9, wherein the second support part is provided to be detachable from the position regulation part.

12. The method of claim 9, wherein the position regulation part is provided in a plural number and connects the first support part and the second support part in a vertical direction.

13. The method of claim 9, wherein the initial position information of the sensor part includes at least one of information on a slope formed by the second support part and the sensor part, and information on a width, a height, and an angle formed by the first support part and the sensor part.

14. The method of claim 9, wherein the position regulation part is configured that the initial position information of the sensor part is maintained based on spatial map information obtained by the sensor part.

15. A computer-readable recording medium on which a program is recorded for executing the assembly method of a smart distribution vehicle according to claim 9.
